(19) United States
(12) Patent Application Publication
(10) Pub. No.: US 2025/0240346 A1
(43) Pub. Date: Jul. 24, 2025

(54) PROBABILITY-BASED LOAD BALANCING

(71) Applicant: Microsoft Technology Licensing, LLC, Redmond, WA (US)

(72) Inventors: Bohan WANG, Suzhou, Jiangsu (CN); Shuo CHEN, Suzhou, Jiangsu (CN); Yang Zhang, Suzhou, Jiangsu (CN)

(21) Appl. No.: 18/855,593

(22) PCT Filed: Mar. 1, 2023
(86) PCT No.: PCT/US2023/014200

§ 371 Date: Oct. 9, 2024

(30) Foreign Application Priority Data
May 11, 2022 (CN) 202210513571.X

(51) Int. Cl. H04L 67/1031; H04L 67/1008; H04L 67/1025

(52) U.S. Cl. CPC H04L 67/1031; H04L 67/1008; H04L 67/1025

(57) ABSTRACT

The present disclosure proposes a method, apparatus and computer program products for probability-based load balancing. A current server list may be obtained, the current server list including a set of currently used servers in a server cluster. A change probability curve may be determined. At least one current server to be removed may be identified from the current server list based on the change probability curve. At least one candidate server for replacing the at least one current server may be searched in a candidate server list based on the change probability curve. The current server list may be updated through replacing the at least one current server with the at least one candidate server. Data traffic to be sent may be allocated based on the updated current server list, so as to achieving load balancing in the server cluster.

### BACKGROUND

Load Balancing is a technique widely used in computer networks, which may often be used to distribute workloads to a plurality of servers to improve overall efficiency and throughput of websites, applications, databases, or other services. For example, data traffic or requests from clients may be sent to a plurality of servers in a server cluster through the load balancing technology, so as to achieve effect of traffic sharing.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter.

Embodiments of the present disclosure propose a method, apparatus and computer program product for probability-based load balancing. A current server list may be obtained, the current server list including a set of currently used servers in a server cluster. A change probability curve may be determined, the change probability curve indicating correspondence between a server load level and a server change probability. At least one current server to be removed may be identified from the current server list based on the change probability curve. At least one candidate server for replacing the at least one current server may be searched in a candidate server list based on the change probability curve, the candidate server list including a set of underloaded servers in the server cluster. The current server list may be updated through replacing the at least one current server with the at least one candidate server. Data traffic to be sent may be allocated based on the updated current server list, so as to achieving load balancing in the server cluster.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for probability-based load balancing according to an embodiment of the present disclosure.

FIG. 2 illustrates an exemplary architecture for implementing probability-based load balancing according to an embodiment of the present disclosure.

FIGS. 3A-3D illustrate exemplary change probability curves according to embodiments of the present disclosure.

FIG. 4 illustrates an exemplary process for identifying, from a current server list, a current server to be removed according to an embodiment of the present disclosure.

FIG. 5 illustrates an exemplary process for searching, in a candidate server list, a candidate server for replacing a current serve according to an embodiment of the present disclosure.

FIG. 6 is a flowchart of an exemplary method for probability-based load balancing according to an embodiment of the present disclosure.

FIG. 7 illustrates an exemplary apparatus for probability-based load balancing according to an embodiment of the present disclosure.

FIG. 8 illustrates an exemplary apparatus for probability-based load balancing according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure. There are multiple load balancing strategies, e.g., a random strategy, a round-robin strategy, a weighted round-robin strategy, etc. These strategies are usually based on the fact that all requests will occupy the same amount of processing time on the server side. Therefore, if requests are allocated evenly to all servers, the load on these servers should be balanced. However, for many applications, different requests tend occupy different processing time. This will result in an uneven distribution of load among servers. In addition, according to the existing load balancing strategy, when a load level of a certain server reaches a preset load level threshold, data traffic originally intended to be sent to the server will be switched to other underloaded servers. If at the same time, load levels of a plurality of servers reach preset load level thresholds, and data traffic originally intended for these servers is switched to a same underloaded server. The underloaded server will receive a large amount of data traffic, which may cause a load level of the server to exceed the load level threshold. Subsequently, data traffic to be sent to this server will be switched to other servers. This reciprocation will cause periodic oscillations in load levels of some servers. In addition, due to frequent switching of connections to servers, a large amount of connection switching overheads will be generated, which will further increase load levels of the servers.

Embodiments of the present disclosure propose probability-based load balancing. For example, a change probability curve indicating correspondence between a server load level and a server change probability may be determined. A current server list may be updated based on the change probability curve. Data traffic to be sent may be allocated based on the updated current server list, so as to achieving load balancing in a server cluster. The server load level may be determined based on Central Processing Unit (CPU) usage or Asynchronous Thread Queue (ATQ) of a server. The server change probability may be the probability of whether the server is to change. For example, when a server is a server in a current server list, the change probability may be the probability that the server is to be removed from the current server list. Herein, a currently used server may be referred to as a current server, and a list including a set of current servers may be referred to as a current server list. A current server with a higher load level is more likely to be removed from a current server list. There are also some servers in a server cluster that are not currently in use. These servers may often be underloaded servers. Herein, a server that is not currently used may be referred to as a candidate server, and a list including a set of candidate servers may be referred to as a candidate server list. When a server is a candidate server, a change probability may be the probability that the candidate server is to be selected to replace a current server. A candidate server with a lower load level is more likely to be selected to replace a current server. The approach described above introduces a probability-based negative feedback mechanism. A server with a high load level may gradually and smoothly transfer load to a server with a low load level, so that load levels of all servers converge to an average load level, thereby achieving load balancing in the server cluster. In addition, since load may be evenly distributed in the server cluster, the probability that a load level of an individual server will reach a load level threshold will be reduced, which will increase overall capacity of the server cluster and improve availability of services.

In an aspect, the embodiments of the present disclosure propose to determine a change probability curve based on a load level convergence requirement, a connection switching overhead requirement, etc., of a server cluster. The change probability curve may include a first point with a first load level and a first change probability. When a change probability of a current server is the first change probability, if a candidate server for replacing the current server is searched from a candidate server list, the current server may be replaced with the candidate server. The first change probability may correspond to a first load level. The first load level may be set based on a load level convergence requirement, a connection switching overhead requirement, etc., of a server cluster. For example, when load levels of the server cluster are expected to be able to converge quickly, the first load level may be set to a lower value; and when the server cluster is expected to have lower connection switching overheads, the first load level may be set to a higher value. The change probability curve may also include a line segment with a load level range and a second change probability. When a change probability of a current server in a current server list is the second change probability, the current server may be reserved in the current server list instead of being replaced by a candidate server. In addition, when a change probability of a candidate server in the candidate server list is the second change probability, the candidate server may be reserved in the candidate server list instead of replacing a current server with the candidate server. That is, when the change probability of the current server or the candidate server is the second change probability, the current server or the candidate server may not change. The second change probability may correspond to a load level range. The load level range may be set based on a load level convergence requirement, a connection switching overhead requirement, etc., of a server cluster. For example, when load levels of the server cluster are expected to be able to converge quickly, the load level range may be set to a single load level; and when the server cluster is expected to have lower connection switching overheads, the load level range may be set to a load level interval bounded by two load levels. The change probability curve may further include a second point with a second load level and a third change probability. When a change probability of a candidate server in the candidate server list is the third change probability, the candidate server may be determined as a candidate server for replacing a current server. The third change probability may correspond to a second load level. The second load level may be set based on a load level convergence requirement, a connection switching overhead requirement, etc., of a server cluster. For example, when load levels of the server cluster are expected to be able to converge quickly, the second load level may be set to a higher value; and when the server cluster is expected to have lower connection switching overheads, the second load level may be set to a lower value. A change probability curve determined in the above way may facilitate to implement a load balancing strategy that meets a load level convergence requirement, a connection switching overhead requirement, etc., of a server cluster.

In another aspect, the embodiments of the present disclosure propose to identify, from a current server list, a current server to be removed based on a change probability curve. For example, for each current server in a current server list, it may be first determined whether a load level of the current server is higher than a first load level. If the load level of the current server is higher than the first load level, the current server may be identified as a current server to be removed. If the load level of the current server is not higher than the first load level, it may be further determined whether the current server is a current server to be removed according to a current change probability corresponding to the current server. Through employing a change probability curve, a current server with a higher load level is more likely to be removed from a current server list.

In yet another aspect, the embodiments of the present disclosure propose to searching, in a candidate server list, a candidate server for replacing a current server to be removed based on a change probability curve. For example, for each candidate server in a candidate server list, it may be first determined whether a load level of the candidate server is lower than a second load level. If the load level of the candidate server is lower than the second load level, the candidate server may be selected for replacing a current server. If the load level of the candidate server is not lower than the second load level, it may be further determined whether the candidate server may be selected for replacing a current server according to a change probability corresponding to the candidate server. Through employing a change probability curve, a candidate server with a lower load level is more likely to be selected for replacing a current server.

In still another aspect, the embodiments of the present disclosure propose to perform the probability-based load balancing strategy described above through a load balancer in an arbitrary client in a client system. The client system may be a distributed system including a set of clients, which may be connected to a server cluster via a network. A load balancer in each client may obtain a current server list and load levels of various servers, and may update the current server list based on a change probability curve and the load levels of various servers. The updated current server list may be used to allocate data traffic to be sent at the client. Since each client updates the current server list based on the change probability, the current server list at different clients is likely to be different at a same instant. Accordingly, at a same instant, data traffic at different clients is likely to be allocated to different servers, rather than data traffic at all clients being allocated to a same server at a same instant. In this way, a smooth transfer of data traffic may be achieved, thereby avoiding periodic oscillations in load levels of servers, and further reducing connection switching overheads.

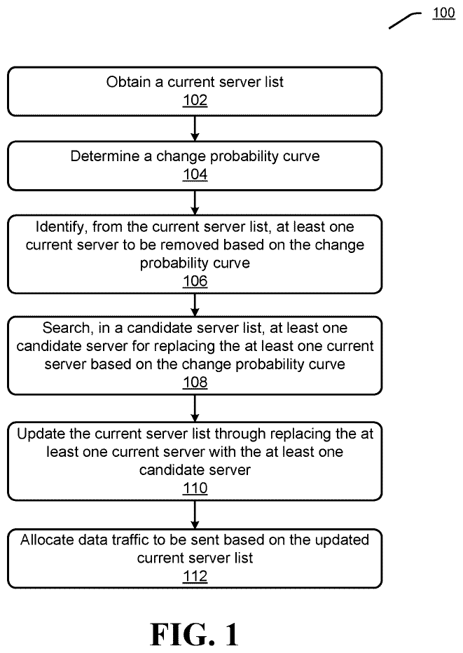

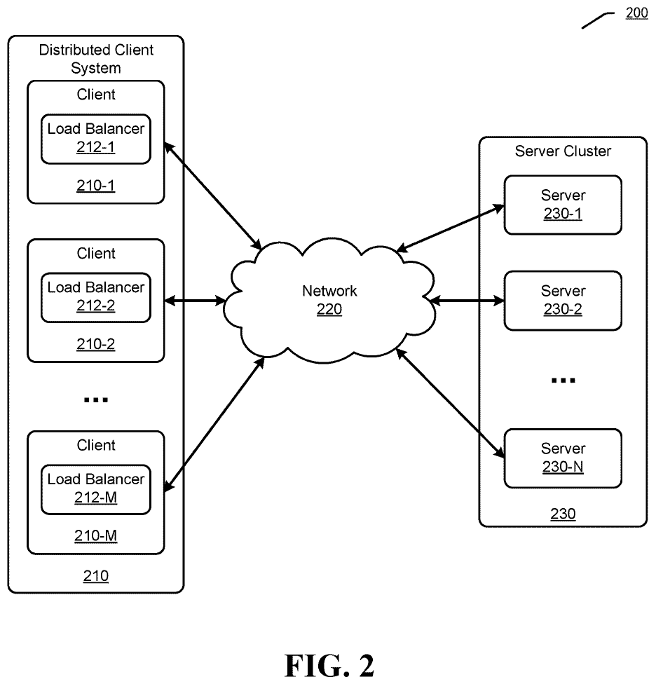

FIG. 1 illustrates an exemplary process 100 for probability-based load balancing according to an embodiment of the present disclosure. The process 100 may be performed through a load balancer in an arbitrary client in a client system. FIG. 2 illustrates an exemplary architecture 200 for implementing probability-based load balancing according to an embodiment of the present disclosure. The architecture 200 may include a distributed client system 210. The distributed client system 210 may include a set of clients, e.g., a client 210-1, a client 210-2, . . . , a client 210-M, where M is the number of clients included in the distributed client system 210. Each client 210-i (1≤i≤M) may include a corresponding load balancer 212-i. Accordingly, the distributed client system 210 may include a set of load balancers, e.g., a load balancer 212-1, a load balancer 212-2, . . . , a load balancer 212-M. The method for probability-based load balancing according to the embodiments of the present disclosure may be performed through a load balancer 212-i in an arbitrary client 210-i in the distributed client system 210.

At 102, a current server list may be obtained. For example, a current server list may be obtained through a service discovery process at a client. The current server list may include a set of currently used servers in a server cluster. Referring to FIG. 2, the architecture 200 may include a server cluster 230. The distributed client system 210 may be connected to the server cluster 230 via a network 220. The server cluster 230 may include a set of servers, e.g., a server 230-1, a server 230-2, . . . , a server 230-N, where N is the number of servers included in the server cluster 230. N may be a number much smaller than M. The server cluster 230 may also be referred to as a server forest. A server in the server cluster 230 may also be referred to as a server instance. The obtained current server list may be saved in a load balancer in a client. Preferably, each server in the current server list may be an available or healthy server. For example, the operational status of each current server in the current server list may be checked through known operational status checking techniques. If a current server fails this operational status check, the current server will be identified as an unavailable or unhealthy server and will be removed from the current server list.

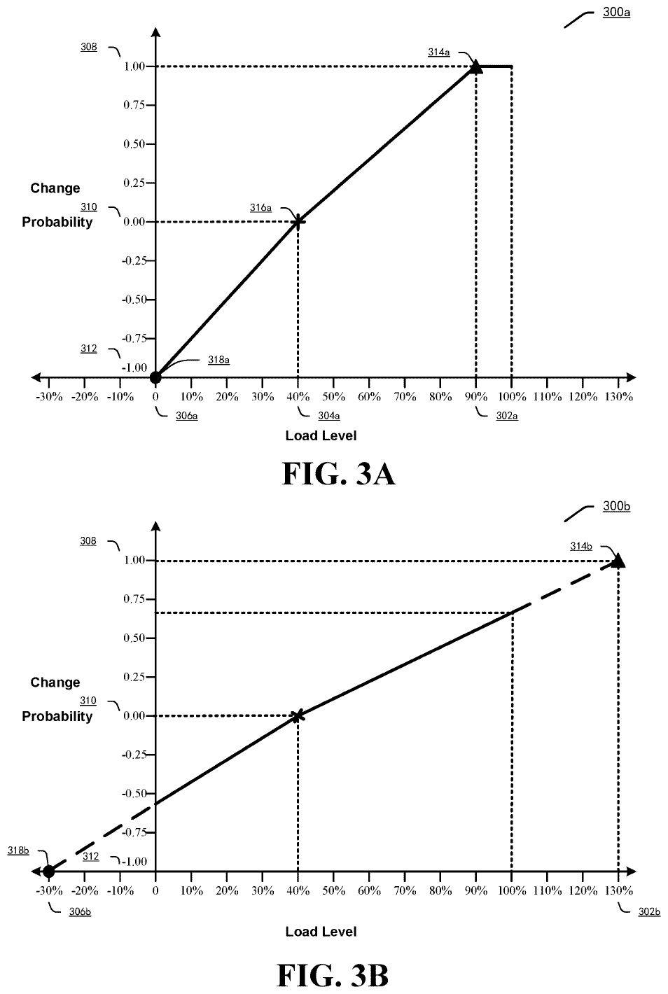

At 104, a change probability curve may be determined. A change probability curve may indicate correspondence between a server load level and a server change probability. The change probability curve may be determined based on a load level convergence requirement, a connection switching overhead requirement, etc., of a server cluster. The change probability curve may include a first point with a first load level and a first change probability. When a change probability of a current server is the first change probability, if a candidate server for replacing the current server is searched from a candidate server list, the current server may be replaced with the candidate server. The first change probability may be a predetermined value, e.g., “1.00”. The first change probability may correspond to a first load level. The first load level may be set based on a load level convergence requirement, a connection switching overhead requirement, etc., of a server cluster. The change probability curve may also include a line segment with a load level range and a second change probability. When a change probability of a current server in a current server list is the second change probability, the current server may be reserved in the current server list instead of being replaced by a candidate server. In addition, when a change probability of a candidate server in a candidate server list is the second change probability, the candidate server may be reserved in the candidate server list instead of replacing a current server with the candidate server. That is, when the change probability of the current server or the candidate server is the second change probability, the current server or the candidate server may not change. The second change probability may be a predetermined value, e.g., “0.00”. The second change probability may correspond to a load level range. The load level range may be set based on a load level convergence requirement, a connection switching overhead requirement, etc., of a server cluster. The change probability curve may further include a second point with a second load level and a third change probability. When a change probability of a candidate server in a candidate server list is the third change probability, the candidate server may be determined as a candidate server for replacing a current server. The third change probability may be a predetermined value, e.g., “−1.00”. The third change probability may correspond to a second load level. The second load level may be set based on a load level convergence requirement, a connection switching overhead requirement, etc., of a server cluster. Exemplary forms of the change probability curve will be described later in conjunction with FIGS. 3A-3D.

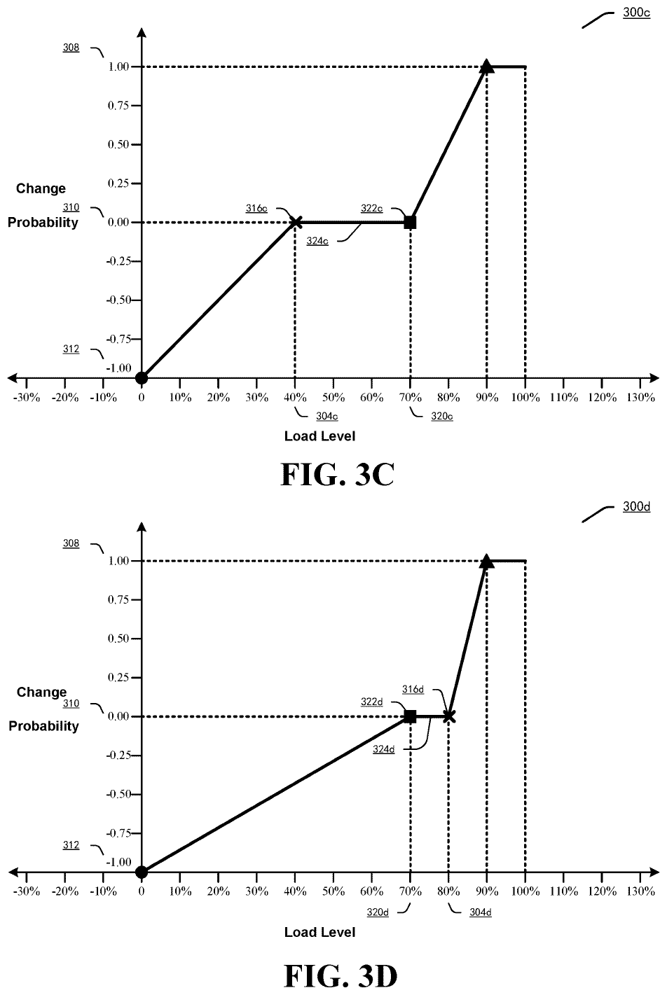

At 106, at least one current server to be removed may be identified from the current server list based on the change probability curve determined at 104. In an implementation, for each current server in the current server list, it may be first determined whether a current load level of the current server is higher than the first load level. Herein, a load level of a current server may be referred to as a current load level. If the current load level of the current server is higher than the first load level, the current server may be identified as a current server to be removed. If the current load level of the current server is not higher than the first load level, it may be further determined whether the current server is a current server to be removed according to a current change probability corresponding to the current server. Herein, a change probability corresponding to the current server may be referred to as a current change probability. An exemplary process for identifying, from a current server list, a current server to be removed will be described later in conjunction with FIG. 4.

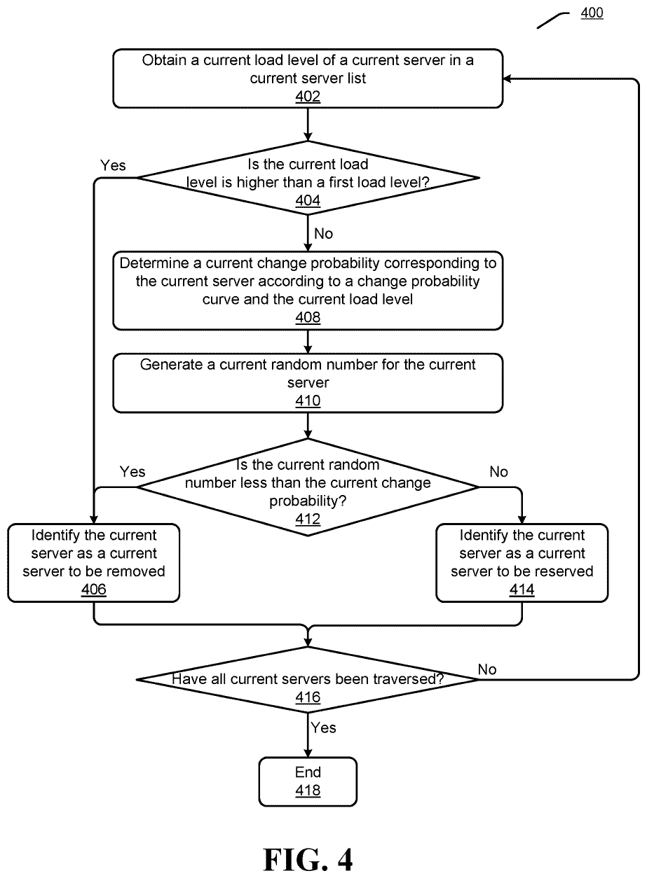

At 108, at least one candidate server for replacing the at least one current server to be removed may be searched in a candidate server list based on the change probability curve determined at 104. The candidate server list may include a set of underloaded servers in the server cluster. When a plurality of current servers to be removed are identified from the current server list, for each current server of the plurality of current servers to be removed, a candidate server for replacing the current server may be searched. In an implementation, for each candidate server in the candidate server list, it may be first determined whether a candidate load level of the candidate server is lower than a second load level. Herein, a load level of a candidate server may be referred to as a candidate load level. If the candidate load level of the candidate server is lower than the second load level, the candidate server may be selected for replacing a current server. If the load level of the candidate server is not lower than the second load level, it may be further determined whether the candidate server may be selected for replacing the current server according to a candidate change probability corresponding to the candidate server. Herein, a change probability corresponds to a candidate server may be referred to as a candidate change probability. An exemplary process for searching, in a candidate server list, a candidate server for replacing a current server to be removed will be described later in conjunction with FIG. 5. It should be appreciated that for a certain current server to be removed, it is possible that no candidate server for replacing the current server is searched in the candidate server list. In this case, the current server will be reserved in the current server list. Preferably, each candidate server in the candidate server list may be an available or healthy server. For example, the operational status of each candidate server in the candidate server list may be checked through known operational status checking techniques. If a candidate server fails this operational status check, the candidate server will be identified as an unavailable or unhealthy server and will be removed from the candidate server list.

At 110, the current server list may be updated through replacing the at least one current server to be removed identified at 106 with the at least one candidate server searched at 108. For each current server in the at least one current server to be removed, if a candidate server for replacing the current server is searched in the candidate server list, the current server may be replaced with the candidate server; while if no candidate server for replacing the current server is searched in the candidate server list, the current server may be reserved in the current server list.

At 112, data traffic to be sent may be allocated based on the updated current server list, so as to achieving load balancing in the server cluster. For example, each client in a distributed client system may have an updated current server list. Data traffic to be sent which is at the client may be allocated based on the updated current server list. Since each client updates the current server list based on the change probability, the current server list at different clients is likely to be different at a same instant. Accordingly, at a same instant, data traffic at different clients is likely to be allocated to different servers, rather than data traffic at all clients being allocated to a same server at a same instant. In this way, a smooth transfer of data traffic may be achieved, thereby avoiding periodic oscillations in load levels of servers, and further reducing connection switching overheads.

It should be appreciated that the process for probability-based load balancing described above in conjunction with FIG. 1 is merely exemplary. Depending on actual application requirements, the steps in the process for probability-based load balancing may be replaced or modified in any manner, and the process may include more or fewer steps. In addition, the specific order or hierarchy of the steps in the process 100 is merely exemplary, and the process for probability-based load balancing may be performed in an order different from the described one.

FIGS. 3A-3D illustrate exemplary change probability curves 300a-300d according to the embodiments of the present disclosure. A change probability curve may indicate correspondence between a server load level and a server change probability. The change probability curve may be determined based on a load level convergence requirement, a connection switching overhead requirement, etc., of a server cluster. In FIGS. 3A to 3D, the horizontal axis shows server load levels, and the vertical axis shows server change probabilities. The change probability curve may include a first point with a first load level and a first change probability, a line segment with a load level range and a second change probability, a second point with a second load level and a third change probability, etc. The first change probability, the second change probability and the third change probability may be predetermined values. For example, the first change probability may be “1.00”, the second change probability may be “0.00”, and the third change probability may be “−1.00”. It should be appreciated that the first change probability, the second change probability and the third change probability may also be set to other values. The first load level, the load level range, and the second load level may be set based on a load level convergence requirement, a connection switching overhead requirement, etc., of a server cluster.

The change probability curve may include the first point with the first load level and the first change probability. According to the embodiments of the present disclosure, when a change probability of a current server is the first change probability, if a candidate server for replacing the current server is searched from the candidate server list, the current server may be removed from the current server list and the candidate server may be added to the current server list. That is, the current server may be replaced with the candidate server. The first change probability may correspond to the first load level. When a load level of a current server in a current server list is higher than the first load level, i.e., when a change probability of the current server is the first change probability, the current server may be identified as a current server to be removed. The first load level may be set based on a load level convergence requirement, a connection switching overhead requirement, etc., of a server cluster. For example, when load levels of the server cluster are expected to be able to converge quickly, the first load level may be set to a lower value; and when the server cluster is expected to have lower connection switching overheads, the first load level may be set to a higher value.

As an example, referring to FIG. 3A, the change probability curve 300a may include a first point 314a with a first load level 302a and a first change probability 308. The first load level 302a may be “90%”. Referring to FIG. 3B, the change probability curve 300b may include a first point 314b with a first load level 302b and a first change probability 308. The first load level 302b may be “130%”. It should be appreciated that the actual load level should lie between “0” and “100%”. In FIG. 3B, setting the first load level 302b to a value greater than “100%” may cause a change probability corresponding to a current server less than the first change probability when a load level of the current server reaches “100%”. That is, there is still a certain probability that the current server will not be removed from the current server list. Comparing the change probability curve 300a and the change probability curve 300b, the first load level 302a “90%” is lower than the first load level 302b “130%”. When the change probability curve 300a is used for load balancing, a faster load level convergence speed may be obtained, while connection switching overheads are larger. When the change probability curve 300b is used for load balancing, a slower load level convergence speed may be obtained, while connection switching overheads are less.

The change probability curve may also include a line segment with the load level range and the second change probability. According to the embodiment of the present disclosure, when a change probability of a current server in a current server list is the second change probability, the current server may be reserved in the current server list instead of being replaced by a candidate server. In addition, when a change probability of a candidate server in a candidate server list is the second change probability, the candidate server may be reserved in the candidate server list instead of replacing a current server with the candidate server. That is, when the change probability of the current server or the candidate server is the second change probability, the current server or the candidate server may not change. The second change probability may correspond to the load level range. The load level range may be defined in a number of ways. In an implementation, an average load level of a server cluster may be obtained. This average load level may be defined as the load level range. That is, in this case, the load level range includes only a single load level. Accordingly, the line segment with such a load level range will be converged into a single point. In another implementation, an average load level of a server cluster may be obtained. In addition, a predetermined load level that triggers load balancing may also be set. The predetermined load level may be, e.g., a preset load level threshold, e.g., “70%”. A load level interval between the average load level and the predetermined load level may be defined as the load level range. The average load level may be calculated based on load levels of all servers in the server cluster. Since the load levels of the servers are dynamically changing and measured in real time, the average load level may be updated in real time. Accordingly, an updated average load level may be obtained, and a load level range may be updated with the updated average load level. The line segment with the load level range and the second change probability may be set based on a load level convergence requirement, a connection switching overhead requirement, etc., of a server cluster. For example, when load levels of a server cluster are expected to be able to converge quickly, the line segment may be set as a single point, i.e., the average load level may be defined as the load level range; and when the server cluster is expected to have lower connection switching overheads, the line segment may be set as a range between the average load level and the predetermined load level that triggers load balancing, i.e., the load level interval between the average load level and the predetermined load level may be defined as the load level range. Additionally, the predetermined load level that triggers load balancing may also be set based on a load level convergence requirement, a connection switching overhead requirement, etc., of a server cluster. For example, when load levels of a server cluster are expected to be able to converge quickly, the predetermined load level may be set to a value closer to the average load level; and when the server cluster is expected to have lower connection switching overheads, the predetermined load level may be set to a value further away from the average load level.

As an example, referring to FIG. 3A, in the change probability curve 300a, the second change probability 310 only corresponds to a single load level, i.e., a load level 304a. The load level 304a may be the average load level of the server cluster. The average load level may be calculated based on load levels of all servers in the server cluster, e.g., “40%” shown in FIG. 3A. Accordingly, the change probability curve 300a may include a point 316a with the load level 304a and a second change probability 310. Referring to FIG. 3C, in the change probability curve 300c, the second change probability 310 corresponds to a load level range from a load level 304c to a load level 320c. The load level 304c may be the average load level of the server cluster. The load level 320c may be a predetermined load level that triggers load balancing. In this case, the change probability curve 300c may include a line segment 324c bounded by the point 316c and the point 322c. Referring to FIG. 3D, in the change probability curve 300d, the second change probability 310 corresponds to a load level range from a load level 320d to a load level 304d. The load level 320d may be a predetermined load level that triggers load balancing. The load level 304d may be the average load level of the server cluster. In this case, the change probability curve 300d may include a line segment 324c bounded by a point 322d and a point 316d. In FIG. 3D, the load level 304d representing the average load level of the server cluster is “80%”, which is higher than a load level 320d “70%” representing the predetermined load level that triggers load balancing, which indicates that the overall load level of the server cluster is at a higher level. In this case, load balancing may still be achieved based on the change probability curve.

The change probability curve may further include the second point with the second load level and the third change probability. When a change probability of a candidate server in a candidate server list is the third change probability, the candidate server may be determined as a candidate server for replacing the current server. The third change probability may correspond to the second load level. The second load level may be set based on a load level convergence requirement, a connection switching overhead requirement, etc., of a server cluster. For example, when load levels of the server cluster are expected to be able to converge quickly, the second load level may be set to a higher value; and when the server cluster is expected to have lower connection switching overheads, the second load level may be set to a lower value.

As an example, referring to FIG. 3A, the change probability curve 300a may include a second point 318a with a second load level 306a and a third change probability 312. The second load level 306a may be “0”. Referring to FIG. 3B, the change probability curve 300b may include a second point 318b with a second load level 302b and a third change probability 312. The second load level 302b may be “−30%”. It should be appreciated that the actual load level should lie between “0” and “100%”. In FIG. 3B, setting the second level 302b to a value less than “0” may cause a change probability corresponding to a candidate server greater than the third change probability when a load level of the candidate server reaches “0”. That is, there is still a certain probability that the candidate server will not be selected for replacing a current server. Comparing the change probability curve 300a and the change probability curve 300b, the second load level 306a “0” is higher than the second load level 306b “−30%”. When the change probability curve 300a is used for load balancing, a faster load level convergence speed may be obtained, while connection switching overheads are larger. When the change probability curve 300b is used for load balancing, a slower load level convergence speed may be obtained, while connection switching overheads are less.

After the first point with the first load level and the first change probability, the line segment with the load level range and the second change probability, the second point with the second load level and the third change probability, etc., are set, a change probability curve may be determined based on these points, line segments, etc. Since the actual load level should lie between “0” and “100%”, the change probability curve should include line segments whose load level is between “0” and “100%”. When the first load level is a value lower than “100%”, a change probability of a line segment with a load level between the first load level and “100%” may be the first change probability, i.e., “1.00”, as shown in FIGS. 3A, 3C and 3D. In addition, when the second load level is a value higher than “0”, a change probability of a line segment with a load level between “0” and the second load level may be the second change probability, i.e., “−1.00”.

FIGS. 3A-3D illustrate some exemplary change probability curves. Such change probability curves may facilitate to implement a load balancing strategy that meets a load level convergence requirement and a connection switching overhead requirement of a server cluster. It should be appreciated that the change probability curves 300a to 300d shown in FIGS. 3A-3D are merely some examples of change probability curves. Depending on actual application requirements, the change probability curve may also have other forms. For example, in the change probability curves 300a to 300d, the relationship between the load level and the change probability is linear, but in some embodiments, the relationship between the load level and the change probability may also be non-linear.

FIG. 4 illustrates an exemplary process 400 for identifying, from a current server list, a current server to be removed according to an embodiment of the present disclosure. The process 400 may correspond to the step 106 in FIG. 1. The process 400 may be performed iteratively for a current server list based on a change probability curve. The change probability curve may be any one of the change probability curves 300a to 300d as shown in FIGS. 3A to 3D, or may be a change probability curve of other forms.

At 402, a current load level of a current server in a current server list may be obtained. For example, a current load level of a current server may be obtained through a service discovery process at a client. The current load level of the current server may be determined based on CPU usage or ATQ of the current server.

At 404, it may be determined whether the current load level is higher than a first load level. The first load level may be determined, e.g., from a change probability curve. Taking the change probability curve 300a in FIG. 3A as an example, the first load level 302a is “90%”. In this case, it may be determined whether the current load level is higher than “90%”.

If it is determined at 404 that the current load level of the current server is higher than the first load level, the process 400 may proceed to 406, where the current server may be identified as a current server to be removed.

Subsequently, the process 400 may proceed to 416, where it is determined whether all current servers in the current server list have been traversed. If it is determined at 416 that all current servers in the current server list have been traversed, the process 400 may end at 418. If it is determined at 416 that not all current servers in the current server list have been traversed, the process 400 may return to 402. At 402, a current load level of a next current server in the current server list may be obtained. Then, subsequent steps may be performed for this next current server.

If it is determined at 404 that the current load level of the current server is not higher than the first load level, it may be further determined whether the current server is a current server to be removed according to a current change probability corresponding to the current server. For example, the process 400 may proceed to 408. At 408, a current change probability corresponding to the current server may be determined according to the change probability curve and the current load level. As an example, assume the change probability curve is the change probability curve 300a in FIG. 3A, and the current load level is “65%”. In this case, the current change probability may be determined as “0.50”.

At 410, a current random number for the current server may be generated. Herein, a random number for a current server may be referred to as a current random number. The current random number may be a number located between the first change probability and the second change probability. Continuing taking the change probability curve being the change probability curve 300a in FIG. 3A as an example, the first change probability 308 is “1.00”, and the second change probability 310 is “0.00”. In this case, a random number between “1.00” and “0.00” may be generated.

At 412, it may be determined whether the generated current random number is less than the current change probability of the current server. For example, in the case where the current change probability is “0.50”, it may be determined whether the generated current random number is less than “0.50”.

If it is determined at 412 that the generated current random number is less than the current change probability of the current server, the process 400 may proceed to 406, where the current server may be identified as a current server to be removed. Subsequently, the process 400 may proceed to 416 and subsequent steps are performed as described above.

If it is determined at 412 that the generated current random number is not less than the current change probability of the current server, the process 400 may proceed to 414, where the current server may be identified as a current server to be reserved. Subsequently, the process 400 may proceed to 416 and subsequent steps are performed as described above.

Through the process 400, one or more current server to be removed may be identified from the current server list based on the change probability curve. Through employing the change probability curve, a current server with a higher load level is more likely to be removed from the current server list. It should be appreciated that it is also possible that no current server to be removed is identified from the current server list. For example, current load levels of all current servers in the current server list may all be lower than the first load level, and generated current random numbers may all be greater than current change probabilities of the current servers. In this case, all current servers in the current server list will be identified as current servers to be reserved.

It should be appreciated that the process for identifying, from a current server list, a current server to be removed described above in conjunction with FIG. 4 is merely exemplary. Depending on actual application requirements, the steps in the process for identifying, from a current server list, a current server to be removed may be replaced or modified in any manner, and the process may include more or fewer steps. In addition, the specific order or hierarchy of the steps in the process 400 is merely exemplary, and the process for identifying, from a current server list, a current server to be removed may be performed in an order different from the described one.

According to the embodiments of the present disclosure, after a current server to be removed is identified from a current server list, it may be further determined whether a candidate server for replacing the current server may be searched in a candidate server list. If a candidate server for replacing a current server is searched, the current server may be replaced with the candidate server, and the current server list may be updated accordingly. If no candidate server for replacing a current server is searched, the current server may be reserved in the current server list.

FIG. 5 illustrates an exemplary process 500 for searching, in a candidate server list, a candidate server for replacing a current serve according to an embodiment of the present disclosure. The process 500 may correspond to the step 108 in FIG. 1. The process 500 may be performed iteratively for a candidate server list based on a change probability curve. The change probability curve used by the process 500 may be consistent with the change probability curve used by the process 400. For example, the change probability curve may be any one of the change probability curves 300a to 300d as shown in FIGS. 3A to 3D, or may be a change probability curve of other forms.

At 502, a candidate load level of a candidate server in a candidate server list may be obtained. For example, a candidate load level of a candidate server may be obtained through a service discovery process at a client. The candidate load level of the candidate server may be determined based on CPU usage or ATQ of the candidate server.

At 504, it may be determined whether the candidate load level is lower than a second load level. The second load level may be determined, e.g., from a change probability curve. Taking the change probability curve 300a in FIG. 3A as an example, the second load level 306a is “0”. In this case, it may be determined whether the candidate load level is lower than “0”.

If it is determined at 504 that the candidate load level of the candidate server is lower than the second load level, the process 500 may proceed to 506, where the candidate server may be determined as a candidate server for replacing a current server. That is, in this case, a candidate server for replacing a current server is searched from the candidate server list. Subsequently, the process 500 may end at 516.

If it is determined at 504 that the candidate load level of the candidate server is not lower than the second load level, it may be further determined whether the candidate server is a candidate server that is able to be used for replacing a current server according to a candidate change probability corresponding to the candidate server. For example, the process 500 may proceed to 508. At 508, a candidate change probability corresponding to the candidate server may be determined according to the change probability curve and the candidate load level. As an example, assume the change probability curve is the change probability curve 300a in FIG. 3A, and the candidate load level is “20%”. In this case, the candidate change probability may be determined as “−0.50”.

At 510, a candidate random number for the candidate server may be generated. Herein, a random number for a candidate server may be referred to as a candidate random number. The candidate random number may be a number located between the second change probability and the third change probability. Continuing taking the change probability curve being the change probability curve 300a in FIG. 3A as an example, the second change probability 310 is “0.00”, and the third change probability 312 is “−1.00”. In this case, a random number between “0.00” and “−1.00” may be generated.

At 512, it may be determined whether the generated candidate random number is greater than the candidate change probability of the candidate server. For example, in the case where the candidate change probability is “−0.50”, it may be determined whether the generated candidate random number is greater than “−0.50”.

If it is determined at 512 that the generated candidate random number is greater than the candidate change probability of the candidate server, the process 500 may proceed to 506, where the candidate server may be determined as a candidate server for replacing a current server. Subsequently, the process 500 may end at 516.

If it is determined at 512 that the generated candidate random number is not greater than the candidate change probability of the candidate server, the process 500 may proceed to 514, where it may be determined whether all candidate servers in the candidate server list have been traversed. If it is determined at 514 that not all candidate servers in the candidate server list have been traversed, the process 500 may return to 502. At 502, a candidate load level of a next candidate server in the candidate server list may be obtained. Then, subsequent steps may be performed for this next candidate server.

If it is determined at 514 that all candidate servers in the candidate server list have been traversed, the process 500 may end at 516. At this point, no candidate server for replacing a current server is searched from the candidate server list.

If a candidate server for replacing a current server is searched in the candidate server list, the current server may be replaced with the candidate server, and the current server list may be updated accordingly. If no candidate server for replacing a current server is searched in the candidate server list, the current server may be reserved in the current server list.

In the process 500, through employing a change probability curve, a candidate server with a lower load level is more likely to be selected for replacing a current server. It should be appreciated that the process for searching, in a candidate server list, a candidate server for replacing a current server described above in conjunction with FIG. 5 is merely exemplary.

Depending on actual application requirements, the steps in the process for searching a candidate server for replacing a current server may be replaced or modified in any manner, and the process may include more or fewer steps. In addition, the specific order or hierarchy of the steps in the process 500 is merely exemplary, and the process for searching a candidate server for replacing a current server may be performed in an order different from the described one.

A mathematical explanation of the probability-based load balancing strategy according to the embodiments of the present disclosure will be set forth below. L(t) may be used to represent a load level of a single server at time t. According to the probability-based load balancing strategy of the embodiments of the present disclosure, data traffic received by a server between time t and time t+dt may be proportional to the difference between its load level L(t) at time t and the average load level L_{avg} of a server cluster, as shown by the following equation:

$$L ( t + d t ) - L ( t ) = - C * ( L ( t ) - {L}_{a v g} ) d t \qquad ( 1 )$$

where C is a normalization coefficient.

Through dividing both sides of the equal sign of the equation (1) by dt, and combining the definition of derivative,

$${L}^{′} ( t ) = - C * ( L ( t ) - {L}_{a v g} ) \qquad ( 2 )$$

may be obtained.

Further, through solving the equation (2),

$$L ( t ) = {L}_{a v g} + exp [ - C t ] \qquad ( 3 )$$

may be obtained.

From the equation (3), it may be seen that the probability-based load balancing strategy according to the embodiments of the present disclosure implements exponential decay from the original load level L(t) to the average load level L_{avg}, so that the load level of the server may gradually and smoothly converge to the average load level.

According to the probability-based load balancing strategy of the embodiments of the present disclosure, a change probability curve indicating correspondence between a server load level and a server change probability may be determined. A current server list may be updated based on the change probability curve. Data traffic to be sent may be allocated based on the updated current server list, so as to achieving load balancing in a server cluster. This approach introduces a probability-based negative feedback mechanism, which may cause a current server with a higher load level more likely to be removed from a current server list, and a candidate server with a lower load level more likely to be selected for replacing a current server. Therefore, a server with a high load level may gradually and smoothly transfer load to a server with a low load level, so that load levels of all servers converge to an average load level, thereby achieving load balancing in the server cluster. In addition, since load may be evenly distributed in the server cluster, the probability that a load level of an individual server will reach a load level threshold will be reduced, which will increase overall capacity of the server cluster and improve availability of services.

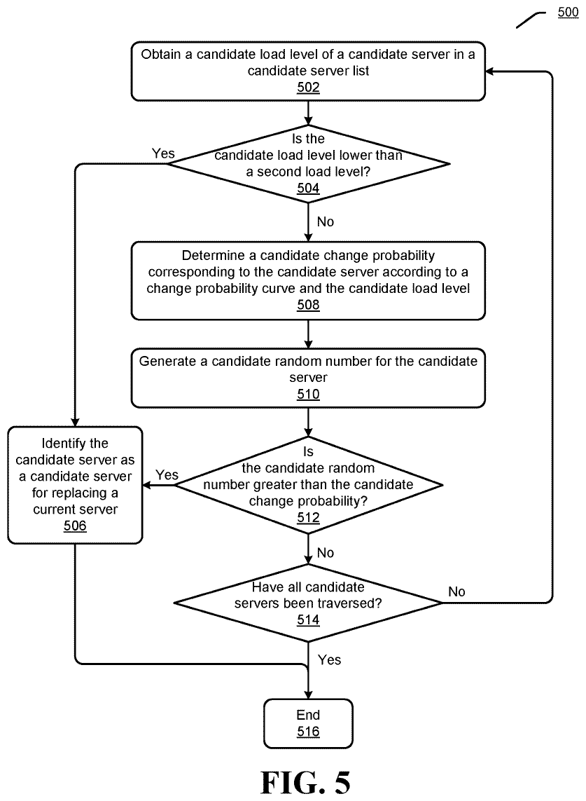

FIG. 6 is a flowchart of an exemplary method 600 for probability-based load balancing according to an embodiment of the present disclosure.

At 610, a current server list may be obtained, the current server list including a set of currently used servers in a server cluster.

At 620, a change probability curve may be determined, the change probability curve indicating correspondence between a server load level and a server change probability.

At 630, at least one current server to be removed may be identified from the current server list based on the change probability curve.

At 640, at least one candidate server for replacing the at least one current server may be searched in a candidate server list based on the change probability curve, the candidate server list including a set of underloaded servers in the server cluster.

At 650, the current server list may be updated through replacing the at least one current server with the at least one candidate server.

At 660, data traffic to be sent may be allocated based on the updated current server list, so as to achieving load balancing in the server cluster.

In an implementation, the determining a change probability curve may comprise: determining the change probability curve based on a load level convergence requirement and/or a connection switching overhead requirement of the server cluster.

In an implementation, the change probability curve may include: a first point with a first load level and a first change probability, and a line segment with a load level range and a second change probability.

The load level range may be defined through: obtaining an average load level of the server cluster; and defining the average load level as the load level range.

The load level range may be defined through: obtaining an average load level of the server cluster; setting a predetermined load level that trigger load balancing; and defining a load level interval between the average load level and the predetermined load level as the load level range. The method 600 may further comprise: obtaining an updated average load level; and updating the load level range with the updated average load level.

The identifying at least one current server to be removed may comprise iteratively performing the following operations on the current server list: obtaining a current load level of a current server in the current server list; determining whether the current load level is higher than the first load level; and in response to determining that the current load level is higher than the first load level, identifying the current server as a current server to be removed.

The method 600 may further comprise: in response to determining that the current load level is not higher than the first load level, determining a current change probability corresponding to the current server according to the change probability curve and the current load level; generating a current random number for the current server, the current random number being between the first change probability and the second change probability; determining whether the current random number is less than the current change probability; and in response to determining that the current random number is less than the current change probability, identifying the current server as a current server to be removed.

The change probability curve may further include: a second point with a second load level and a third change probability.

The searching at least one candidate server for replacing the at least one current server may comprise iteratively performing the following operations on the candidate server list: obtaining a candidate load level of a candidate server in the candidate server list; determining whether the candidate load level is lower than the second load level; and in response to determining that the candidate load level is lower than the second load level, determining the candidate server as a candidate server for replacing the current server.

The method 600 may further comprise: in response to determining that the candidate load level is not lower than the second load level, determining a candidate change probability corresponding to the candidate server according to the change probability curve and the candidate load level; generating a candidate random number for the candidate server, the candidate random number being between the second change probability and the third change probability; determining whether the candidate random number is greater than the candidate change probability; and in response to determining that the random number is greater than the candidate change probability, determining the candidate server as a candidate server for replacing the current server.

In an implementation, each server in the current server list or the candidate server list may be an available server.

In an implementation, the method 600 may be performed through a load balancer in an arbitrary client in a client system. The client system may be connected with the server cluster via a network.

The allocating data traffic to be sent may comprise: allocating the data traffic to be sent which is at the arbitrary client based on the updated current server list.

It should be appreciated that the method 600 may further include any step/process for probability-based load balancing according to the embodiment of the present disclosure as mentioned above.

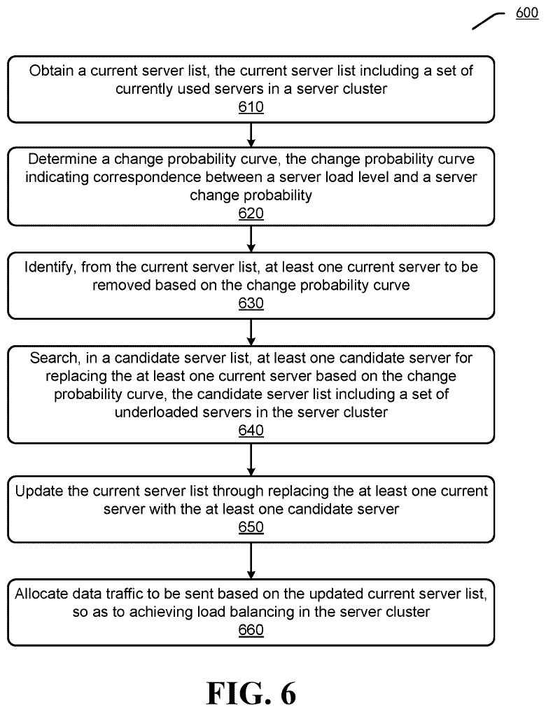

FIG. 7 illustrates an exemplary apparatus 700 for probability-based load balancing according to an embodiment of the present disclosure.

The apparatus 700 may comprise: a current server list obtaining module 710, for obtaining a current server list, the current server list including a set of currently used servers in a server cluster; a change probability curve determining module 720, for determining a change probability curve, the change probability curve indicating correspondence between a server load level and a server change probability; a current server identifying module 730, for identifying, from the current server list, at least one current server to be removed based on the change probability curve; a candidate server searching module 740, for searching, in a candidate server list, at least one candidate server for replacing the at least one current server based on the change probability curve, the candidate server list including a set of underloaded servers in the server cluster; a current server list updating module 750, for updating the current server list through replacing the at least one current server with the at least one candidate server; and a data traffic allocating module 760, for allocating data traffic to be sent based on the updated current server list, so as to achieving load balancing in the server cluster. Moreover, the apparatus 700 may further comprise any other modules configured for probability-based load balancing according to the embodiments of the present disclosure as mentioned above.

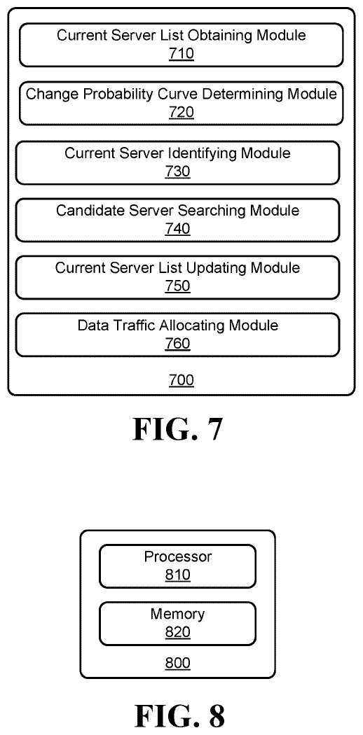

FIG. 8 illustrates an exemplary apparatus 800 for probability-based load balancing according to an embodiment of the present disclosure.

The apparatus 800 may comprise at least one processor 810 and a memory 820 storing computer-executable instructions. The computer-executable instructions, when executed, may cause the at least one processor 810 to: obtain a current server list, the current server list including a set of currently used servers in a server cluster, determine a change probability curve, the change probability curve indicating correspondence between a server load level and a server change probability, identify, from the current server list, at least one current server to be removed based on the change probability curve, search, in a candidate server list, at least one candidate server for replacing the at least one current server based on the change probability curve, the candidate server list including a set of underloaded servers in the server cluster, update the current server list through replacing the at least one current server with the at least one candidate server, and allocate data traffic to be sent based on the updated current server list, so as to achieving load balancing in the server cluster.

In an implementation, the change probability curve may include: a first point with a first load level and a first change probability, and a line segment with a load level range and a second change probability.

The identifying at least one current server to be removed may comprise iteratively performing the following operations on the current server list: obtaining a current load level of a current server in the current server list; determining whether the current load level is higher than the first load level; and in response to determining that the current load level is higher than the first load level, identifying the current server as a current server to be removed.

The change probability curve may further include: a second point with a second load level and a third change probability.

The searching at least one candidate server for replacing the at least one current server may comprise iteratively performing the following operations on the candidate server list: obtaining a candidate load level of a candidate server in the candidate server list; determining whether the candidate load level is lower than the second load level; and in response to determining that the candidate load level is lower than the second load level, determining the candidate server as a candidate server for replacing the current server.

It should be appreciated that the processor 800 may further perform any other step/process of the method for probability-based load balancing according to the embodiments of the present disclosure as mentioned above. In addition, the memory 820 may also store other information, e.g., the current server list and load level information of each current server on the current server list, the candidate service list and load level information of each candidate server on the candidate server list, etc.

The embodiments of the present disclosure propose a computer program product for probability-based load balancing, comprising a computer program that is executed by at least one processor for: obtaining a current server list, the current server list including a set of currently used servers in a server cluster; determining a change probability curve, the change probability curve indicating correspondence between a server load level and a server change probability; identifying, from the current server list, at least one current server to be removed based on the change probability curve; searching, in a candidate server list, at least one candidate server for replacing the at least one current server based on the change probability curve, the candidate server list including a set of underloaded servers in the server cluster; updating the current server list through replacing the at least one current server with the at least one candidate server; and allocating data traffic to be sent based on the updated current server list, so as to achieving load balancing in the server cluster. In addition, the computer program may further be performed for implementing any other steps/processes of the method for probability-based load balancing according to the embodiments of the present disclosure as mentioned above.

The embodiments of the present disclosure may be embodied in a non-transitory computer-readable medium. The non-transitory computer readable medium may comprise instructions that, when executed, cause one or more processors to perform any operation of the method for probability-based load balancing according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform. Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for probability-based load balancing, comprising:
obtaining a current server list, the current server list including a set of currently used servers in a server cluster;
determining a change probability curve, the change probability curve indicating correspondence between a server load level and a server change probability;
identifying, from the current server list, at least one current server to be removed based on the change probability curve;
searching, in a candidate server list, at least one candidate server for replacing the at least one current server based on the change probability curve, the candidate server list including a set of underloaded servers in the server cluster;
updating the current server list through replacing the at least one current server with the at least one candidate server; and
allocating data traffic to be sent based on the updated current server list, so as to achieving load balancing in the server cluster.

2. The method of claim 1, wherein the determining a change probability curve comprises:
determining the change probability curve based on a load level convergence requirement and/or a connection switching overhead requirement of the server cluster.

3. The method of claim 1, wherein the change probability curve includes:
a first point with a first load level and a first change probability, and
a line segment with a load level range and a second change probability.

4. The method of claim 3, wherein the load level range is defined through:
obtaining an average load level of the server cluster; and
defining the average load level as the load level range.

5. The method of claim 3, wherein the load level range is defined through:
obtaining an average load level of the server cluster;
setting a predetermined load level that trigger load balancing; and
defining a load level interval between the average load level and the predetermined load level as the load level range.

6. The method of claim 4, further comprising:
obtaining an updated average load level; and
updating the load level range with the updated average load level.

7. The method of claim 3, wherein the identifying at least one current server to be removed comprises iteratively performing the following operations on the current server list:
obtaining a current load level of a current server in the current server list;
determining whether the current load level is higher than the first load level; and
in response to determining that the current load level is higher than the first load level, identifying the current server as a current server to be removed.

8. The method of claim 7, further comprising:
in response to determining that the current load level is not higher than the first load level, determining a current change probability corresponding to the current server according to the change probability curve and the current load level;
generating a current random number for the current server, the current random number being between the first change probability and the second change probability;
determining whether the current random number is less than the current change probability; and
in response to determining that the current random number is less than the current change probability, identifying the current server as a current server to be removed.

9. The method of claim 3, wherein the change probability curve further includes:
a second point with a second load level and a third change probability.

10. The method of claim 9, wherein the searching at least one candidate server for replacing the at least one current server comprises iteratively performing the following operations on the candidate server list:
obtaining a candidate load level of a candidate server in the candidate server list;
determining whether the candidate load level is lower than the second load level; and
in response to determining that the candidate load level is lower than the second load level, determining the candidate server as a candidate server for replacing the current server.

11. The method of claim 10, further comprising:
in response to determining that the candidate load level is not lower than the second load level, determining a candidate change probability corresponding to the candidate server according to the change probability curve and the candidate load level;
generating a candidate random number for the candidate server, the candidate random number being between the second change probability and the third change probability;
determining whether the candidate random number is greater than the candidate change probability; and
in response to determining that the random number is greater than the candidate change probability, determining the candidate server as a candidate server for replacing the current server.

12. The method of claim 1, wherein the method is performed through a load balancer in an arbitrary client in a client system, the client system connected with the server cluster via a network.

13. The method of claim 12, wherein the allocating data traffic to be sent comprises:
allocating the data traffic to be sent which is at the arbitrary client based on the updated current server list.

14. An apparatus for probability-based load balancing, comprising:
at least one processor; and
a memory storing computer-executable instructions that, when executed, cause the at least one processor to:
obtain a current server list, the current server list including a set of currently used servers in a server cluster,
determine a change probability curve, the change probability curve indicating correspondence between a server load level and a server change probability,
identify, from the current server list, at least one current server to be removed based on the change probability curve,
search, in a candidate server list, at least one candidate server for replacing the at least one current server based on the change probability curve, the candidate server list including a set of underloaded servers in the server cluster,
update the current server list through replacing the at least one current server with the at least one candidate server, and
allocate data traffic to be sent based on the updated current server list, so as to achieving load balancing in the server cluster.

15. A computer program product for probability-based load balancing, comprising a computer program that is executed by at least one processor for:
obtaining a current server list, the current server list including a set of currently used servers in a server cluster;
determining a change probability curve, the change probability curve indicating correspondence between a server load level and a server change probability;
identifying, from the current server list, at least one current server to be removed based on the change probability curve;
searching, in a candidate server list, at least one candidate server for replacing the at least one current server based on the change probability curve, the candidate server list including a set of underloaded servers in the server cluster;
updating the current server list through replacing the at least one current server with the at least one candidate server; and
allocating data traffic to be sent based on the updated current server list, so as to achieving load balancing in the server cluster.
